(19) United States
(12) Patent Application Publication
(10) Pub. No.: US 2016/0268051 A1
(43) Pub. Date: Sep. 15, 2016

(54) POWER INSERTER DEVICE

(71) Applicant: Technetix B.V., Veenendaal (NL)

(72) Inventors: Paul Chapman, West Sussex (GB); Chandith Palawinna, West Sussex (GB)

(21) Appl. No.: 15/067,440

(22) Filed: Mar. 11, 2016

(30) Foreign Application Priority Data
Mar. 13, 2015 (GB) 1504288.0

(51) Int. Cl. H01G 4/40; H01F 27/00

(52) U.S. Cl. CPC H01G 4/40; H01F 27/00

(57) ABSTRACT

A power inserter device is connectable between two-core wire and a CATV device, wherein the power inserter device comprises a conductive elongate rod, at least one inductive element in the form of an apertured disc disposed between at least two capacitive elements each in the form of an apertured disc and the conductive elongate rod extends through the disc apertures and is arranged to physically contact with the capacitive elements. The inductive elements and the capacitive elements physically adjoin and form an electrical path by being in physical contact with each other.

### CROSS-REFERENCE TO RELATED APPLICATION

The present application claims priority under 35 U.S.C. §119 of United Kingdom Patent Application No. 1504288.0, filed Mar. 13, 2015, the disclosure of which is hereby incorporated herein by reference in its entirety.

### FIELD OF THE INVENTION

The present invention relates to a power inserter device, and in particular such a device for supplying power to cable television (CATV) equipment.

### BACKGROUND OF THE INVENTION

Power for devices within a CATV network is usually provided using coaxial shielded cable to supply 60-90 VAC. Sometimes unshielded two-core wires are used to provide power but these generate a large amount of electromagnetic radiation causing problems with electromagnetic shielding and may be 30-40 dB above the official standard for electromagnetic compatibility as defined in IEC 60728-2 and in particular EN 58000 class A.

Using shielded wires is expensive and electromagnetic emissions will still occur, together with interfering RF signal ingress.

### SUMMARY OF THE INVENTION

In accordance with one aspect of the present invention, there is provided a power inserter device connectable between two-core wire and a CATV device, wherein the power inserter device comprises a conductive elongate element, at least one inductive element in the form of an apertured disc disposed between at least two capacitive elements each in the form of an apertured disc and the conductive elongate element extends through the disc apertures and is in direct physical contact with the capacitive elements thereby to create a Pi filter associated with the conductive elongate element. This allows the use of unshielded two-core wire to power a CATV device whilst ensuring the regulatory screening requirements are met.

Preferably, the at least one inductive element and the at least two capacitive elements physically adjoin and form an electrical path by being in physical contact with each other.

The at least one inductive element may be provided by one or more ferrite beads, and preferably by three ferrite beads in the form of apertured discs or rings. Preferably, the inductance of the at least one inductive element will be in the range 80nH to 120nH and more preferably around 100nH.

Preferably, each capacitive element will have a capacitance in the range 4 nF to 5.5 nF and more preferably around 4.7 nF.

Preferably, the conductive elongate element is formed with a shoulder at one end to provide a contact surface with at least one capacitive element. The shoulder has a greater cross-section than the remainder of the elongate element so that a central portion of the elongate element extends through adjoining disc apertures whilst the shoulder provides a locating portion to prevent the central portion touching the inductive elements.

Preferably, the end of the conductive element distal the shoulder portion will be provided with a threaded portion for receiving an electrically conductive nut, so as to form a physical and electrical connection with the other capacitive element. The elongate element is required to extend through the aligned apertures of the disc elements but yet needs to be electrically connected to each capacitor, hence the need for a detachable securing element at at least one end of the rod, typically in the form of an electrically conductive nut.

Preferably, the device will further comprise a conductive ring for providing a path to ground, such that in a two-wire system, a live wire will be in electrical contact with the conductive elongate element and a neutral wire will be in electrical contact with the conductive grounding ring.

The present invention provides an arrangement of physically interconnected components that form a Pi filter associated with the conductive path provided by the conductive elongate element.

### BRIEF DESCRIPTION OF THE DRAWINGS

The present invention will now be described, by way of example, and with reference to the accompanying drawings in which:

FIG. 1 shows a sectional view through a power inserter device in accordance with the present invention;

FIGS. 2(a) and (b) show the power connector device in assembled and exploded views, respectively;

FIG. 3 shows the equivalent electrical circuit for the power inserter device;

FIG. 4 shows a graph of screening effectiveness of the device between 5-30 MHz;

FIG. 5 shows a graph of screening effectiveness of the device between 0-950 MHz; and

FIG. 6 shows a graph of screening effectiveness of the device between 950-1400 MHz.

### DETAILED DESCRIPTION OF THE INVENTION

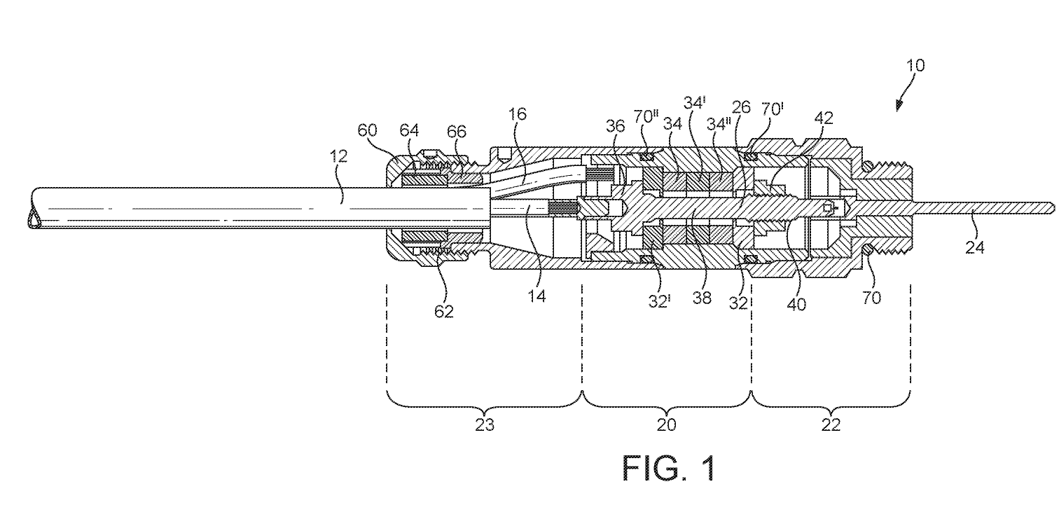

FIG. 1 shows a power inserter device 10 attached to a two-core wire 12, having a live power lead 14 and a neutral power lead 16. The power inserter device comprises a central section 20 connected to a front section 22 and rear section 23. Front section 22 incorporates a KS pin 24 for inserting into a CATV device to supply power from power cable 12.

The power inserter device 10 comprises a central elongate conductive rod 26 which extends through electrical components in the form of adjoining apertured discs with rod 26 arranged to physically and electrically connect to the disc elements forming each end. The electrical components act in combination as a Pi filter. The electrical components comprise two disc capacitors 32, 32′ between which are placed inductive elements in the form of ferrite beads 34, 34′, 34″. All these electrical components are formed with the same size central aperture such that the components adjoin to form a central channel through which rod 26 passes. Whilst three inductive elements, 34, 34′, 34″ are shown, if required only one elongate apertured inductive element may be used. The total inductance of the three ferrite beads is typically around 100nH, with the disc capacitors typically each having a capacitance of 4.7 nF.

Rod 26 is formed with a shoulder section 36 which provides a retaining stop against which capacitive element 32′ abuts. Central section 38 of rod 26 has a reduced cross-sectional diameter compared to shoulder 36 and is situated within the channel formed by the aligned apertured discs so that there is no electrical or physical contact between central section 38 of rod 26 and the discs. The distal end of rod 26 is formed with a threaded section 40 on which a flanged nut 42 is located and tightened to ensure physical contact between shoulder 36, capacitive elements 32, 32′, nut 42, rod 36, and to ensure that the disc elements are pushed together so that they physically and electrically contact one another.

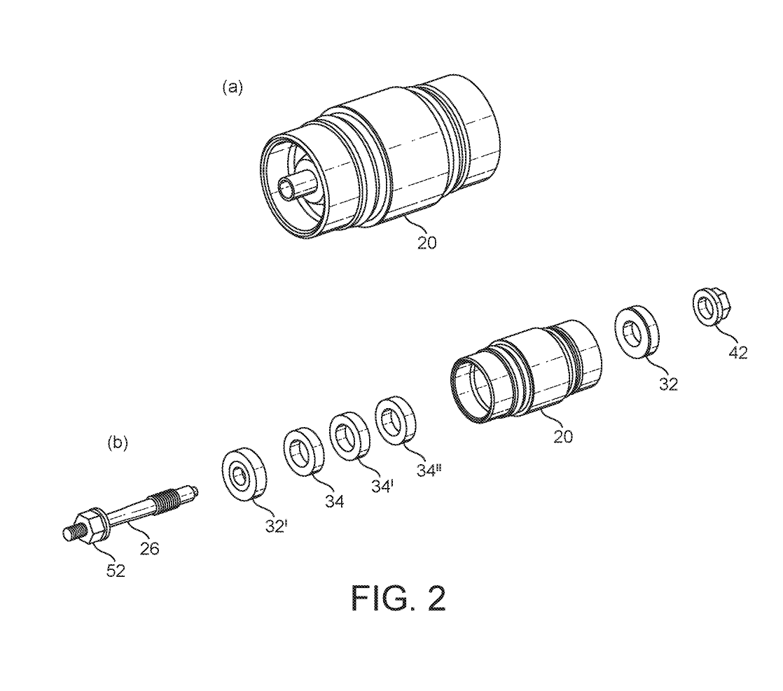

The assembled centre section 20 can be seen in FIG. 2(a) with FIG. 2(b) showing an exploded view of centre section 20 including conductive rod 26, disc capacitors 32, 32′, ferrite beads 34, 34′, 34″ and flanged collar 52 of rod 26 and flange nut 42.

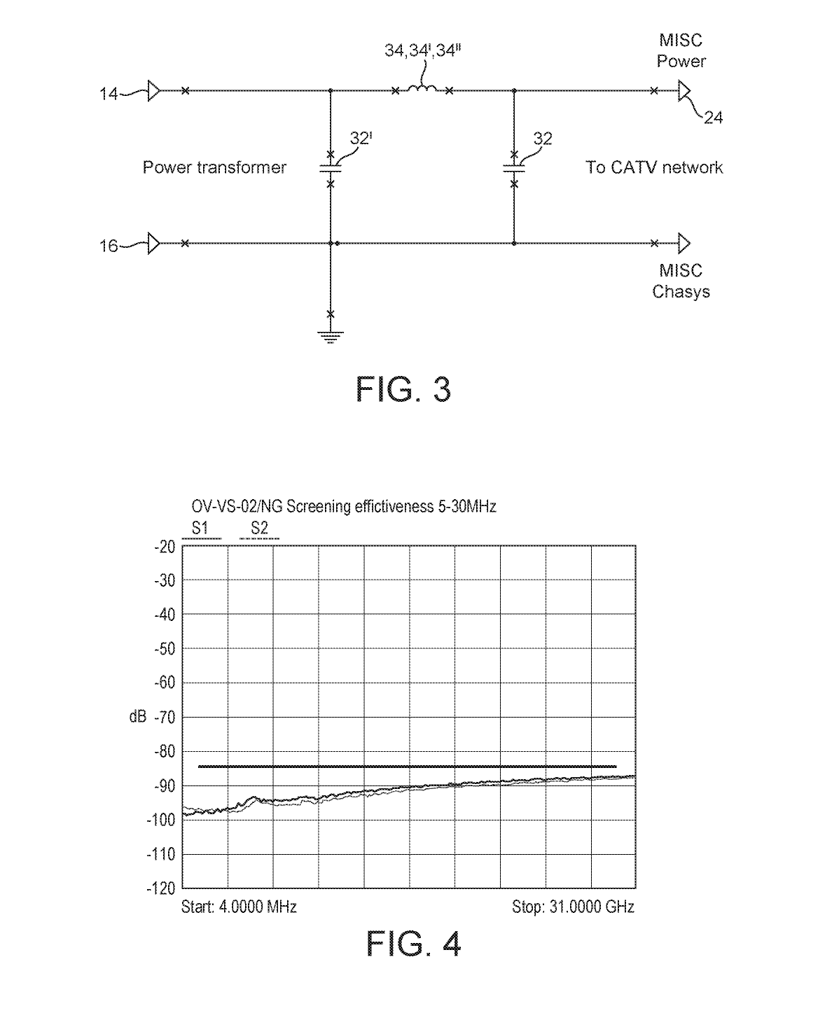

Live wire 14 of power cable 12 is connected to rod 26 using a crimp pin 50 to ensure direct electrical contact between live power lead 14 and rod 26. Neutral power lead 16 is connected to flanged collar 52, such that in combination with electrical components 32, 32′, 34, 34′, 34″ a power source with an associated Pi filter is produced, see FIG. 3.

Although not essential for practicing the present invention, power inserter device 10 has a gland nut 60 which attaches to a threaded portion 62 rear 23 of the power inserter body and in combination with nitrile rubber ring 64 and collet 66 grips power cable 12 and secures it relative to power inserter device 10. O-rings 70, 70′, 70″ are used to assist with sealing the body of device 10 from water ingress.

Power inserter device 10 can be used to power CATV equipment using ordinary two-core wire, with the inductor and capacitors forming a Pi filter that cuts off frequencies above 5 MHz that come out from the CATV device. Power inserter device 10 is a small unit which can be screwed into ⅝″ port (or with a standard coupler used with other types of ports) of CATV distribution equipment to power-up the system. Power is provided to the CATV network using unshielded wires whilst ensuring that the “class A” EMC requirements for passive electromagnetic shielding are met for signals in frequency range of at least 5 MHz to 1400 MHz, and possibly for signals of higher frequency.

The disc capacitors 32, 32′ reduce the effective lead inductance and provide improved reliability as they are robust. Up to 15 Amperes can be input to a CATV system without adding any significant RF interference (AC hum modulation) into the system and with insignificant power dissipation.

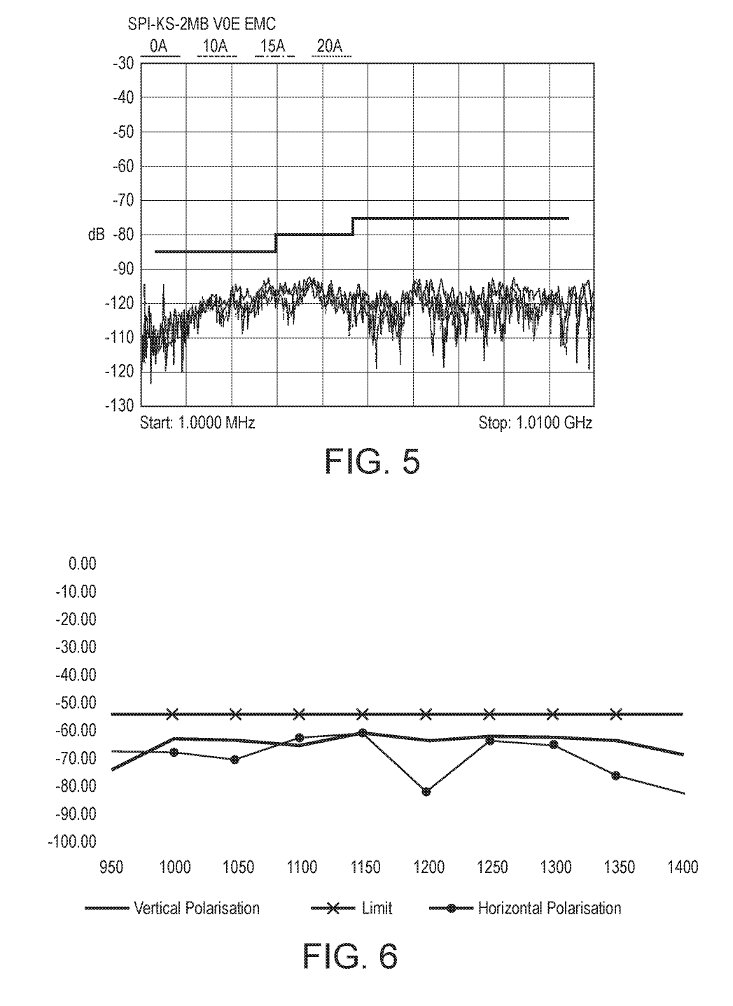

When such a power inserter device is used for signals in the range of 0 MHz to 1400 MHz, screening effectiveness is obtained as shown in FIGS. 4 to 6 with in all cases the obtained screening effectiveness well below the limit of screening effectiveness required to meet the “class A” EMC requirements.

While the present invention has been illustrated by description of various embodiments and while those embodiments have been described in considerable detail, it is not the intention of Applicant to restrict or in any way limit the scope of the appended claims to such details. Additional advantages and modifications will readily appear to those skilled in the art. The present invention in its broader aspects is therefore not limited to the specific details and illustrative examples shown and described. Accordingly, departures may be made from such details without departing from the spirit or scope of Applicant's invention.

What is claimed is:

1. A power inserter device configured to be connected between two-core wire and a CATV device, wherein the power inserter device comprises a conductive elongate element, at least one inductive element in the form of an apertured disc disposed between at least two capacitive elements each in the form of an apertured disc and the conductive elongate element extends through the disc apertures and is arranged to physically contact with the capacitive elements.

2. A power inserter device according to claim 1, wherein the at least one inductive element and the at least two capacitive elements physically adjoin and form an electrical path by being in physical contact with each other.

3. A power inserter device according to claim 1, wherein the at least one inductive element is provided by one or more ferrite beads in the form of apertured discs or rings.

4. A power inserter device according to claim 1, wherein the inductance of the at least one inductive element is in the range 80nH to 120nH.

5. A power inserter device according to claim 1, wherein each capacitive element has a capacitance in the range 4 nF to 5.5 nF.

6. A power inserter device according to claim 1, wherein the conductive elongate element is formed with a shoulder at one end to provide a contact surface with at least one capacitive element.

7. A power inserter device according to claim 6, wherein the shoulder has a greater cross-section than the remainder of the elongate element so that a central portion of the elongate element extends through adjoining disc apertures whilst the shoulder provides a locating portion to prevent the central portion touching any inductive elements.

8. A power inserter device according to claim 6, wherein the end of the conductive element distal the shoulder portion comprises a threaded portion for receiving an electrically conductive nut.

9. A power inserter device according to claim 1, further comprising a conductive ring for providing a path to ground.
